(19) United States
(12) Patent Application Publication
(10) Pub. No.: US 2012/0152835 A1
(43) Pub. Date: Jun. 21, 2012

(54) FUEL CELL DEVICES FOR USE IN WATER TREATMENT AND RECLAMATION PROCESSES

(76) Inventors: Andres Cardenas, Tampa, FL (US); Toler Strawn, Bradenton, FL (US); Tim Short, St. Petersburg, FL (US); Walter McCracken, Safety Harbor, FL (US); Larry Langebrake, Seminole, FL (US)

(21) Appl. No.: 13/328,985

(22) Filed: Dec. 16, 2011

Related U.S. Application Data
(60) Provisional application No. 61/424,456, filed on Dec. 17, 2010.

(51) Int. Cl. H01M 8/16; C02F 3/12; B01D 61/00; C02F 1/48

(52) U.S. Cl. 210/620; 210/748.01; 210/634; 429/2; 429/401

(57) ABSTRACT

In some aspects, the disclosure provides methods and materials for generating electrical energy from wastewater treatment materials. For example, the methods involve selecting a pair of materials from a wastewater treatment facility and forming a microbial fuel cell using the pair of materials as anode and cathode materials. There are provided various configurations suitable for adaptation to existing wastewater treatment facilities, as well as design parameters for new wastewater treatment facilities, devices, or schemes that take advantage of the methods of the disclosure.

### CROSS-REFERENCE TO RELATED APPLICATIONS

This application claims priority under 35 U.S.C. §119(e)(1) to U.S. Provisional Patent Application Ser. No. 61/424,456, filed Dec. 17, 2010, the contents of which are incorporated herein by reference.

### INTRODUCTION

It is estimated that the animal waste produced on an annual basis in the United States has an energy value equivalent to 21 billion gallons of gasoline, and that the organic content of human wastewaters produced in the United States has an annual energy value equivalent to 0.11 quadrillion BTUs. Animal wastewaters produced in the United States have an even greater annual energy potential.

Keeping up with increasing societal energy needs is a challenging task. Energy demands are commonly linked to transportation, manufacturing and industry. Water resource management also requires large amounts of energy, and as a consequence, basic needs such as safe drinking water and adequate sanitation have not been globally satisfied. According to a report by the Pacific Research Institute, the greatest developmental failure of the last century is the lack of sanitation procedures and clean drinking water in the world.

One of the major difficulties in the establishment of proper water treatment processes is the amount of energy traditionally required for sanitation. Therefore, diseases with endemic proportions occur in those underdeveloped countries which do not have the financial resources to provide energy for water sanitation. The number of deaths directly related to the lack sanitized water is estimated to be between two and five million every year, and most of these people are children and persons with weaker immune systems.

A fuel cell is a galvanic device that produces electrical energy as cathode and anode materials are continuously replenished. The most common type of fuel cell is the oxygen-hydrogen cell, where oxygen acts as the cathode (oxidizing material) on one side of the cell, and hydrogen is oxidized in the anode side.

Microbial Fuel Cells (MFCs) couple a cathode reaction, in which an oxidizing compound is reduced, with bacterial metabolic activity that acts as a catalyst on organic matter to produce electronic release, or oxidizes such organic matter. As in other fuel cells, MFCs typically possess a cathode, an anode and a chamber separator (ion exchange medium). Each of these components have been the subject of investigation, mainly in attempts to enhance the low power outputs generated within the cells.

### SUMMARY

In some aspects, the disclosure provides a microbial fuel cell comprising: a cathode positioned in a cathode compartment; an anode positioned in an anode compartment, wherein the anode is in electrical communication with the cathode; an inlet for providing a first material to the anode compartment; and an inlet for providing a second material to the cathode compartment, wherein: the first material is a wastewater composition comprising one or more impurities, and the second material is a wastewater composition comprising one or more impurities, and wherein the first and the second materials differ in composition.

In other aspects, the disclosure provides a microbial fuel cell comprising: a cathode positioned in a cathode compartment; an anode positioned in an anode compartment; a barrier disposed between the cathode compartment and the anode compartment; means for supplying a first material from a wastewater treatment facility to the anode compartment and an optional means for providing a treating material to the anode compartment; and means for supplying a second material from a wastewater treatment facility to the cathode compartment and an optional means for providing a treating material to the cathode compartment, wherein the first material and second material differ in composition.

In yet other aspects, the disclosure provides a method for treating wastewater, the method comprising: supplying a first wastewater material to a cathode compartment, and maintaining the first wastewater material in the cathode compartment for a first predetermined period of time; and supplying a second wastewater material to an anode compartment, and maintaining the second wastewater material in the anode compartment for a second predetermined period of time, wherein the cathode compartment comprises a cathode, and the anode compartment comprises an anode.

In still other aspects, the disclosure provides a method for generating energy in a microbial fuel cell (MFC), the method comprising: supplying a first material from a wastewater treatment facility to an anode compartment, wherein the anode compartment comprises an anode; and supplying a second material from the wastewater treatment facility to a cathode compartment, wherein the cathode compartment comprises a cathode.

In still other aspects, the disclosure provides a microbial fuel cell (MFC) comprising: a cathode positioned in a cathode compartment; an anode positioned in an anode compartment, wherein the anode is in electrical communication with the cathode; an anode inlet for providing a first material to the anode compartment; a cathode inlet for providing a second material to the cathode compartment; an optional anode outlet for removing a treated first material from the anode compartment; and an optional cathode outlet for removing a treated second material from the cathode compartment, provided that at least one of the optional anode outlet and the optional cathode outlet is present, wherein the first material is a wastewater composition comprising one or more impurities, and the second material is a wastewater composition comprising one or more impurities and the first and the second materials differ in composition.

### BRIEF DESCRIPTION OF THE DRAWINGS

FIG. 1a provides a schematic diagram illustrating a galvanic cell according to an embodiment of the disclosure. An anode chamber and a cathode chamber are present within the same container and are separated by an ion permeable membrane.

FIG. 1b provides a schematic diagram illustrating a flow container according to an aspect of the disclosure. Wastewater treatment materials are flowed through the two sides of the container, and are kept separate by an ion permeable membrane. Two example configurations of the membrane are provided.

FIG. 1c provides a schematic diagram illustrating an addition embodiment of a flow container, as described for FIG. 1b. Multiple separate channels are provided through a container. The space surrounding the multiple channels is suitable to flow one wastewater treatment material, while the space within each of the multiple channels is suitable to flow another wastewater treatment material.

FIG. 1d provides a block diagram illustrating a MFC according to an aspect of the disclosure.

FIG. 1e provides a schematic diagram illustrating a flow container according to an aspect of the disclosure. Two wastewater treatment materials are flowed through two channels that are separated by an ion permeable membrane. Into the top of one of the channels, disinfectant is added. The disinfectant sinks via gravity to the bottom of the channel, during which time it acts on the flowing wastewater treatment material.

FIG. 1f provides a schematic diagram illustrating an embodiment of a portable MFC according to an aspect of the disclosure.

FIG. 1g provides a schematic diagram illustrating an addition embodiment of a flow container according to an aspect of the disclosure.

FIG. 2a provides a block and flow diagram of an operating wastewater treatment facility.

FIG. 2b provides a block and flow diagram of a wastewater treatment facility according to an embodiment of the disclosure.

FIG. 3 provides a graph showing Cell potential vs. Current for four data-series obtained from microbial fuel cells.

FIG. 4a provides a graph showing Cell potential vs. Current for three data-series obtained from microbial fuel cells using various materials as cathode current collectors. FIG. 4b provides an expanded view of the section of the graph nearest to the origin from FIG. 4a.

FIG. 5 provides a graph showing Cell potential vs. Current for six data-series obtained from microbial fuel cells on various dates.

FIG. 6 provides a graph showing Cell potential vs. Current for four data-series obtained from microbial fuel cells with electrodes of various sizes.

FIG. 7 provides a graph showing Power vs. Current for the MFCs used in FIG. 6.

FIG. 8 provides a graph showing Cell potential vs. Electric load in ohms (log-scale) obtained from the microbial fuel cells used in FIG. 6.

FIG. 9 provides a graph showing Cell potential vs. the reciprocal of electrode's area (log-scale) obtained from microbial fuel cells of various sizes (i.e., the MFCs shown in FIG. 6).

FIG. 10 provides a graph showing Cell potential vs. Time for three data-series obtained from a microbial fuel according to the disclosure.

FIG. 11 is a graph showing Cell potential vs. Current data-series obtained from microbial fuel cells using various materials as current collectors in the cathode.

FIG. 12 is a graph showing Cell potential vs. Current data-series obtained from microbial fuel cells using various materials as current collectors in the cathode.

FIG. 13 provides a graph of Cell potential vs. Current for three data-series obtained from microbial fuel cells using Palladium coated carbon foil as current collectors.

FIG. 14 provides a graph of Cell potential vs. Current for two data-series using two different electrodes.

FIG. 15 provides a graph showing Cell potential vs. current for four data-series obtained from microbial fuel cells of various sizes.

FIG. 16 provides a graph showing Power vs. Current for the MFCs used in FIG. 15.

FIG. 17 provides a graph showing Cell potential vs. the reciprocal of electrode's area (log-scale) obtained from microbial fuel cells of various sizes. Original data sets are shown in FIGS. 15 and 16.

FIG. 18 provides a graph showing Cell potential vs. the reciprocal of electrode's area (log-scale) obtained by extrapolating the shown “real data” from microbial fuel cells of various sizes.

### DETAILED DESCRIPTION

### Definitions

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described herein. It is understood that the present disclosure supersedes any disclosure of an incorporated publication to the extent there is a contradiction.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

The term “typically” is used to indicate common practices of the invention. The term indicates that such disclosure is exemplary, although (unless otherwise indicated) not necessary, for the materials and methods of the invention. Thus, the term “typically” should be interpreted as “typically, although not necessarily.” Similarly, the term “optionally,” as in a material or component that is optionally present, indicates that the invention includes instances wherein the material or component is present, and also includes instances wherein the material or component is not present.

In some embodiments, the disclosure provides designs for a wastewater treatment facility (WWTF) that take into account concurrent operation of microbial fuel cells (MFCs). In some embodiments the WWTF designs of interest account for and optimize two factors: (1) purification and/or other treatment of wastewater; and (2) generation of electricity using MFCs. For example, in some embodiments the WWTF designs of interest provide a purified water product and electrical current as two outputs.

In some embodiments, the disclosure provides MFCs and methods for operating MFCs using a plurality of materials from a WWTF. Such MFCs, as described in more detail herein, may be designed and operated on any suitable scale, and the outputs of such MFCs include a generated current and may further include a purified water product.

### Components of a WWTF

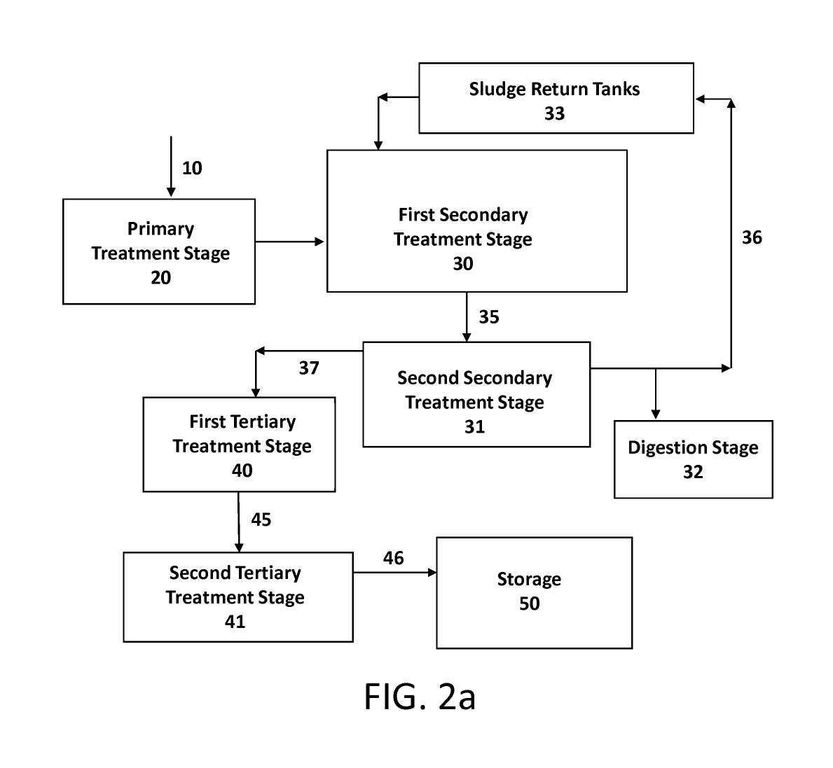

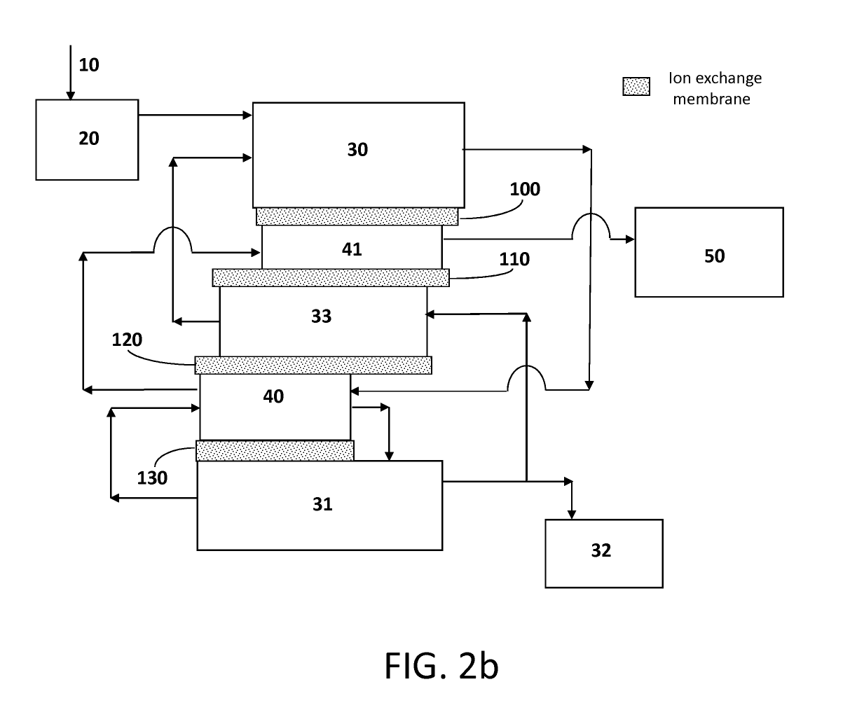

The layout and flow diagram of a WWTF is provided in schematic form in FIG. 2a. Source 10 is an untreated influent and is provided as a wastewater input to the WWTF. For example, sewage water such as water from municipal sewage sources is a typical untreated influent. The various stages of the WWTF are designed to remove all toxic and undesired material from the untreated influent in order to produce a purified water output. Water treatment occurs in three stages identified as primary, secondary, and tertiary treatment stages. Primary treatment involves removal of grit, sand, and other large objects from the influent. Secondary treatment uses aerobic biologic processes to substantially degrade the biological content of the sewage. Liquid from the primary treatment settling tanks goes into aeration tanks where oxygen, organic material and nutrients supply substrate to microorganisms, such as bacteria and protozoa. This process of activated sludge biological treatment uses dissolved oxygen to promote the microorganisms to remove organic material, which in turn, promotes the growth of the biota in the aeration tank. From the aeration tank the liquid passes into a secondary clarification step in which most of the microorganisms settle out and are recycled back to the aeration basin as recycled sludge, and some of the excess is pumped to the solids treatment process. Finally, to ensure the quality of the effluent before being discharged, filtration and chlorination disinfection are used as the last two steps in the treatment process.

In the specific example of FIG. 2a, the first stage in the purification process is primary treatment stage 20, where grit, sand, and other large objects are removed from the influent. The material present in primary treatment stage 20, as well as the output from stage 20, are referred to herein as a filtered untreated influent.

The filtered untreated influent is sent to first secondary treatment stage 30 in which the influent is aerated and treated with microbes. The material present in first secondary treatment stage 30 is referred to herein as Activated Sludge. The Activated Sludge contains microbes and waste materials. The output 35 of first secondary treatment stage 30 is also referred to as Activated Sludge.

The Activated Sludge (i.e., output of first secondary treatment stage 30) is provided to the second secondary treatment stage 31, in which the material is clarified in clarification tanks using chemical and/or mechanical coagulation. The material present in second secondary treatment stage 31 is referred to herein as Clarified Activated Sludge, and contains small particles, microbes, and dissolved waste materials. Two outputs are obtained from second secondary treatment stage 31. The first output (37 in FIG. 2a) is sent to first tertiary treatment stage 40 (described below) and is also referred to herein as Clarified Activated Sludge. The second output (36 in FIG. 2a) is referred to herein as Sludge Return. After solids are removed and are sent to digestion stage 32, Sludge Return 36 is stored in Sludge Return Tanks 33 and/or returned to first secondary treatment stage 30.

The Clarified Activated Sludge (i.e., output 37 of second secondary treatment stage 31) is provided to first tertiary treatment stage 40, in which filtration removes solid particles. The output 45 from first tertiary treatment stage 40 is referred to herein as Filtered Activated Sludge, or alternately as Filtered Treated Effluent.

The Filtered Activated Sludge (i.e., output 45 of first tertiary treatment stage 40) is provided to second tertiary treatment stage 41, in which the influent is treated with a disinfecting material in order to kill and remove microbes and any other potentially toxic materials. Output 46 of the second tertiary treatment stage is referred to as a purified water product and is sent to covered storage 50. The purified water product typically retains some disinfecting material from stage 41, and is kept in covered storage 50 so as to avoid the deposition of airborne particulate matter. In some embodiments, the purified water product is delivered directly to consumers.

Collectively, the outputs from each of the above-described stages are referred to herein as “effluents” and the inputs to each of the above-described stages are referred to herein as “influents.” It will be appreciated that the effluent from one stage may also be the influent to a subsequent stage.

It will further be appreciated that the above description and FIG. 2a describe only one typical embodiment of a WWTF, and is intended as merely representative. Other embodiments of WWTFs are known, and can be adapted to the methods and layouts described herein.

Throughout this disclosure, the material present in any given purification stage and the material output from that purification stage are generally referred to by the same name. For example, the material present in the tanks of first secondary treatment stage 31 and the material exiting first secondary treatment stage 31 are both referred to herein as Activated Sludge. It will be appreciated, however, that the use of the same name does not necessarily imply the same composition. For example, the composition of the Activated Sludge present in the tanks of first secondary treatment stage 31 is not necessarily the same as the composition of the Activated Sludge exiting such tanks. In particular, the material in the tanks is undergoing treatment, and so the composition of the material in the tanks will depend upon a variety of factors (e.g., the location within the tanks, the duration that the material has been in the tanks undergoing treatment, etc.). Nevertheless, the convention of using the same name for the material inside the tanks and the material exiting the tanks is used herein for convenience. An exception to this convention is the material in second tertiary treatment stage 41. Whereas the output from stage 41 is referred to herein as purified water product 46, the material present in second tertiary treatment stage 41 is referred to herein as a Disinfecting Mixture, and is a combination of a disinfecting solution and the effluent from first tertiary treatment stage 40.

### Materials

A number of materials are identified above in the description of a typical WWTF (e.g., Activated Sludge, Clarified Activated Sludge, etc.). As described below, these materials are used in the WWTF designs and MFCs of interest.

In some embodiments, a first wastewater treatment (WWT) material and a second WWT material from a WWTF are used to form a microbial fuel cell (MFC). The two materials comprise liquids, and can be independently selected from solutions, suspensions, or mixtures. The two materials can be selected from any stage or effluent in the WWT process, provided that the compositions of the two materials differ sufficiently to create an electrical potential in the MFC. The two materials are used as cathode material and anode material, and the electrical potential formed between the materials is used to generate electrical current in the MFC.

The materials described above from which the first and second WWT materials are selected are: Untreated Influent; Filtered Untreated Influent; Activated Sludge; Clarified Activated Sludge; Sludge Return; Filtered Activated Sludge; and Disinfecting Mixture. It will be appreciated that this is not an exhaustive list of materials from a WWTF that can be used in the MFCs of interest. Known WWTF designs that differ from the design described above as exemplary may involve different materials having different compositions. Such materials may be used in the MFCs of interest provided that two materials are selected that form an electrical potential in a MFC.

As mentioned above, two materials from a WWT process are selected to function as anode material and cathode material. Whether the first material is used as the cathode or the anode, and whether the second material is used as the cathode or the anode, is determined by the relative electrical potential between the two materials. In order to determine anode and cathode identity, in some embodiments it is convenient to assign each material a relative “oxidizing potential.” A material has a high oxidizing potential if it is highly oxidizing, and a low oxidizing potential if it is minimally oxidizing (more strongly reducing). In a two-component MFC, the material with a higher oxidizing potential will function as the cathode, and the other material will function as the anode. In view of a ranked order of oxidizing potential, then, the cathode solution and anode solution can be identified for any two selected materials. For the materials identified above, the following relative ranking of oxidizing potentials is obtained (in decreasing order of oxidizing potential): Disinfecting Mixture>Activated Sludge>Filtered Activated Sludge>Clarified Activated Sludge>Sludge Return. Thus, in a MFC that uses Disinfecting Mixture as one WWT material and Filtered Activated Sludge as the second WWT material, the chamber holding the Disinfecting Mixture will function as the cathode and the chamber holding the Filtered Activated Sludge will function as the anode. It will be appreciated, however, that this ranking is not intended to be limiting, and that the relative oxidizing potentials for materials from any particular waste treatment facility may vary. Furthermore, the relative oxidizing potential of Untreated Influent and Filtered Untreated Influent will be determined by the composition of the influent, and such composition may vary (e.g., with changes in the source of the influent, the type of influent, local environmental conditions, etc.). The materials listed above are present and obtained from various stages of treatment at wastewater treatment facilities, as described herein.

It will be appreciated that the components of the wastewater materials will vary depending on the source of the influent, the stage of treatment, etc. In some embodiments, the wastewater treatment facility is for treating human waste, livestock waste, industrial waste, or any combination thereof. The components and compositions of wastewater are described, for example, in M. Henze, Wastewater Treatment: Biological and Chemical Processes, 3^{rd} Ed. (Springer, 2002), the contents of which is incorporated by reference.

In some embodiments, the wastewater contains one or more impurities selected from microorganisms, biodegradable organic materials, non-biodegradable organic materials, nutrients, metals, other inorganic materials, and the like. Examples of these materials include bacteria, viruses, worms, larvae, eggs, anionic detergents, cationic detergents, zwitterionic detergents, pesticides, fats, oils, grease, dyes, solvents, phenol, phthalates, polycyclic aromatic hydrocarbons, polymers, acids, bases, mercury, lead, nickel, copper, fertilizers, and the like.

For example, in some embodiments, the wastewater materials used as the anode and/or cathode material include elevated levels of bacteria, microorganisms, biodegradable organic matter, and combinations thereof. By “elevated levels” is meant a level greater than that of potable water, including levels found in municipal sewage.

The wastewater treatment materials used as anode and cathode materials differ in composition. The difference may be in the concentration of one component (i.e., one impurity) or in multiple components. For example, the concentration of one component (e.g., bacteria, a biodegradable organic material, or the like) in the anode material may be greater than the concentration of that component in the cathode material, such as 10% greater, or 25% greater, or 50% greater, or 100% greater, or 3 times greater, or 5 times greater, or 10 times greater, or 100 times greater, or 1000 times greater. Similarly, the concentration of one component (e.g., bacteria, a biodegradable organic material, or the like) in the anode material may be less than the concentration of that component in the cathode material, such as 10% less, or 25% less, or 50% less, or 100% less, or 3 times less, or 5 times less, or 10 times less, or 100 times less, or 1000 times less.

In some embodiments, the concentration of total nitrogen in the wastewater material (used in either the cathode material or anode material) is greater than 30 g/m³, or greater than 50 g/m³, or greater than 75 g/m³ upon entering the cathode or anode. In some embodiments, the concentration of total phosphorus in the wastewater material (used in either the cathode material or anode material) is greater than 3 g/m³, or greater than 5 g/m³, or greater than 8 g/m³, or greater than 10 g/m³. In some embodiments, the concentration of suspended solids in the wastewater material (used in either the cathode material or anode material) is greater than 150 g/m³, or greater than 200 g/m³, or greater than 350 g/m³. In some embodiments, the concentration of coliform bacteria in the wastewater material (used in either the cathode material or anode material) is greater than 10⁸ per 100 ml. In some embodiments, the concentration of E. Coli bacteria in the wastewater material (used in either the cathode material or anode material) is greater than 10⁴ per 100 ml, or greater than 10⁶ per 100 ml. In some embodiments, the concentration of Cl. Perfringens in the wastewater material (used in either the cathode material or anode material) is greater than 10² per 100 ml, or greater than 10³ per 100 ml. In some embodiments, the concentration of Fecal Streptococae bacteria in the wastewater material (used in either the cathode material or anode material) is greater than 10⁴ per 100 ml, or greater than 10⁶ per 100 ml. In some embodiments, the concentration of Salmonella in the wastewater material (used in either the cathode material or anode material) is greater than 1 per 100 ml, or greater than 100 per 100 ml. In some embodiments, the concentration of Campylobacter bacteria in the wastewater material (used in either the cathode material or anode material) is greater than 10² per 100 ml, or greater than 10⁴ per 100 ml. In some embodiments, the concentration of Listeria in the wastewater material (used in either the cathode material or anode material) is greater than 50 per 100 ml, or greater than 10³ per 100 ml. In some embodiments, the concentration of Staphyllococus aureus in the wastewater material (used in either the cathode material or anode material) is greater than 10² per 100 ml, or greater than 10⁴ per 100 ml. In some embodiments, the concentration of Giardia in the wastewater material (used in either the cathode material or anode material) is greater than 10 per 100 ml, or greater than 10³ per 100 ml. In some embodiments, the concentration of E. Coli bacteria in the wastewater material (used in either the cathode material or anode material) is greater than 10⁴ per 100 ml, or greater than 10⁶ per 100 ml. In some embodiments, the concentration of suspended matter in the wastewater material (used in either the cathode material or anode material) is greater than 2 mg per 100 ml, or greater than 20 mg per 100 ml. All of the above amounts refer to concentrations upon entry of the material into the cathode or anode. It will be appreciated that the concentrations of such impurities for materials exiting the cathode or anode (i.e., after treatment) will be significantly reduced, such as reduced by a factor of 2, or by a factor of 5, or by a factor of 10, or by a factor of 50, or by a factor of 100, or by a factor of 500, or by a factor of 1000. For example, the concentration of suspended solids in the material leaving the cathode or anode may be less than 2 mg per 100 ml. Similarly, the concentration of other impurities listed in the material leaving the cathode or anode may be less than the lower value give above for each impurity.

### Configuration

In some embodiments, the MFCs of interest comprise an anode chamber for holding the anode material. The anode chamber can be any convenient chamber of any convenient size. For example, the anode chamber can be a holding tank commonly used in WWTF designs. In some embodiments, such tanks comprise one or more inlet ports, one or more outlet ports, and an optional means for mechanically agitating the material in the tank (e.g., stir bars, rods, blades, brushes, etc.). In some embodiments, in addition to the anode solution, an anode is disposed within the anode chamber.

In some embodiments, the MFCs of interest comprise a cathode chamber for holding the cathode material Like the anode chamber, the cathode chamber can be any convenient chamber of any convenient size. For example, the cathode chamber can be a holding tank commonly used in WWTF designs. Again, in some embodiments, such tanks comprise one or more inlet ports, one or more outlet ports, and an optional means for mechanically agitating the material in the tank (e.g., stir bars, rods, blades, brushes, etc.). In some embodiments, in addition to the cathode solution, a cathode is disposed within the cathode chamber.

In some embodiments, the cathode and anode chambers are containers that hold more than 100 gallons of material, or more than 500 gallons, or more than 1000 gallons, or more than 5000 gallons, or more than 10000 gallons, or more than 50000 gallons, or more than 100000 gallons. In other embodiments, the cathode and anode chambers are containers that hold less than 100 gallons, or less than 50 gallons, or less than 25 gallons, or less than 10 gallons, or less than 5 gallons, or less than 1 gallon.

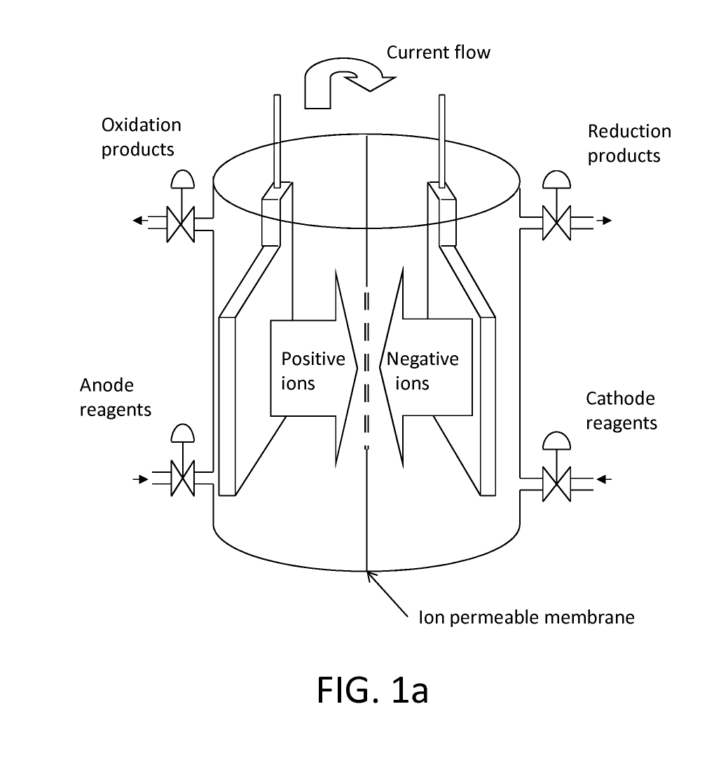

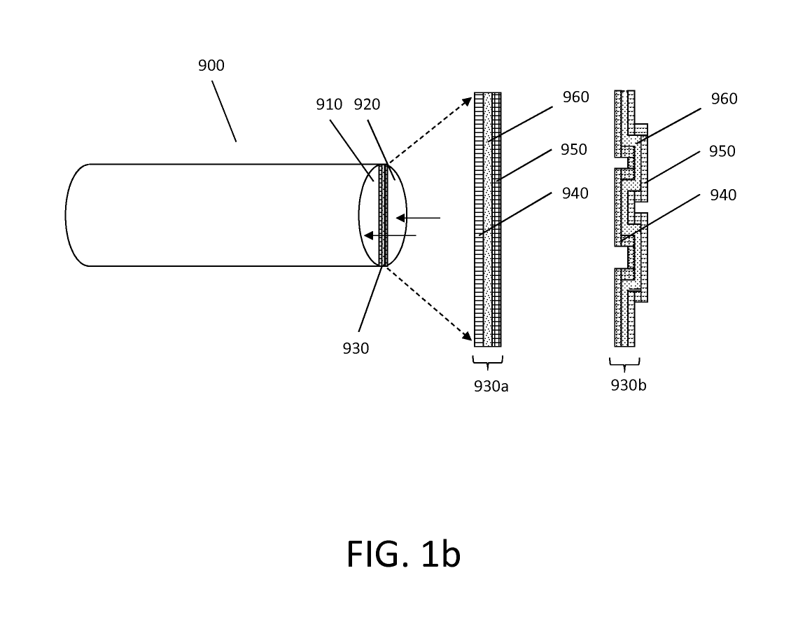

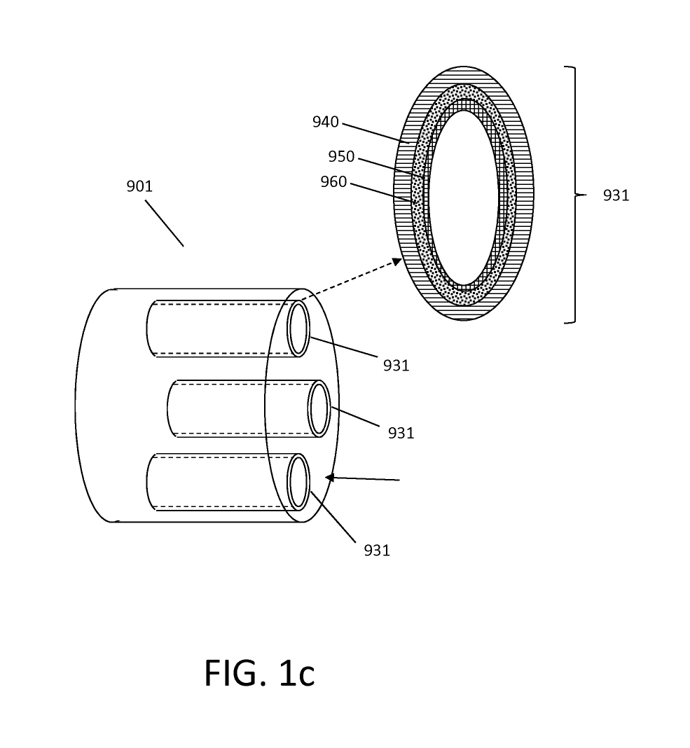

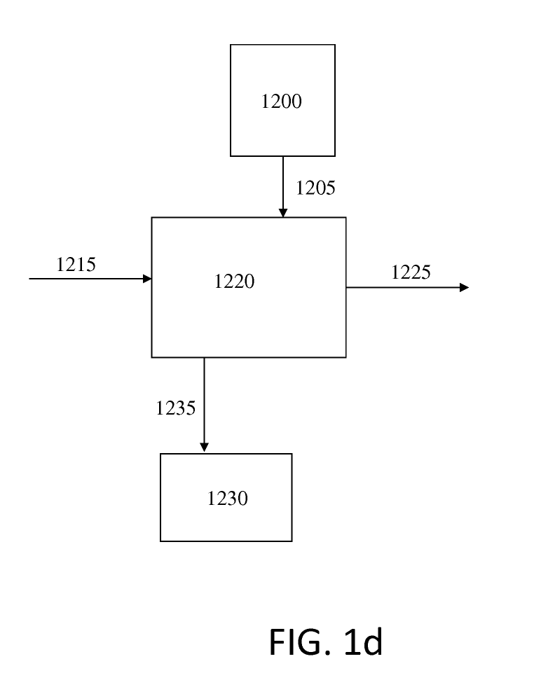

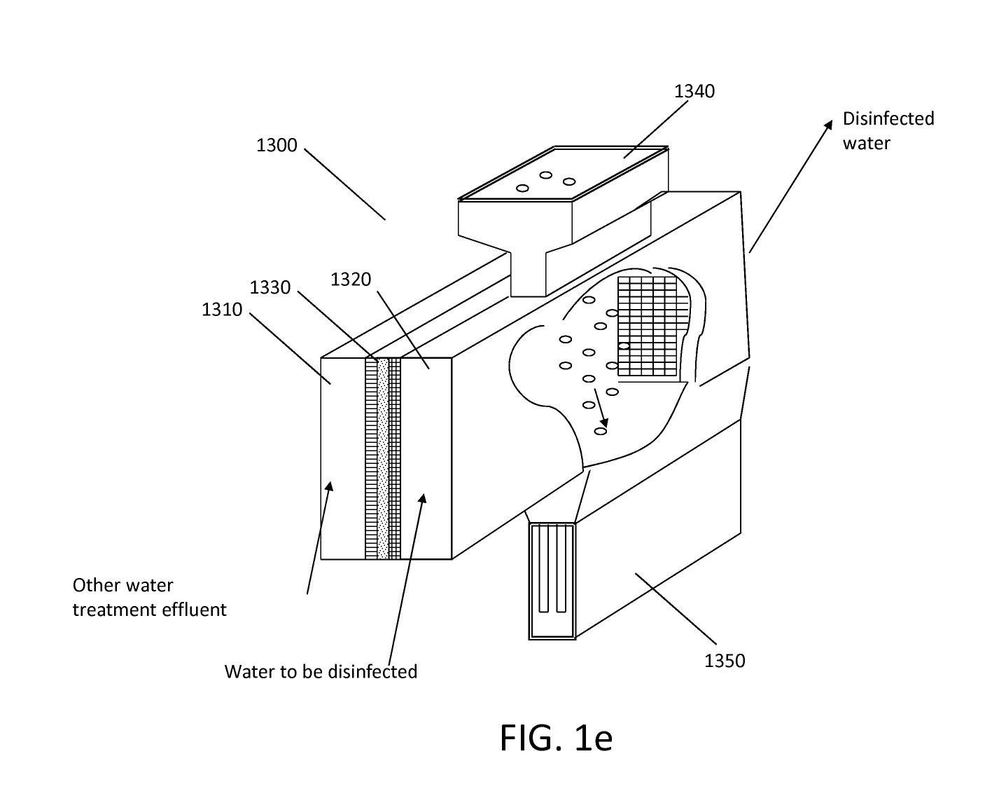

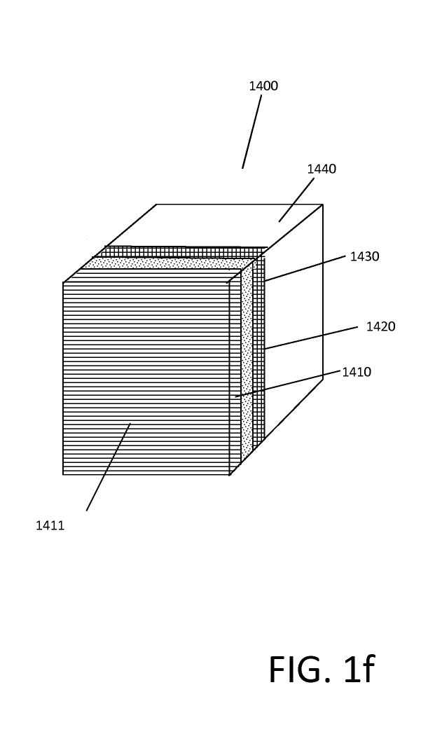

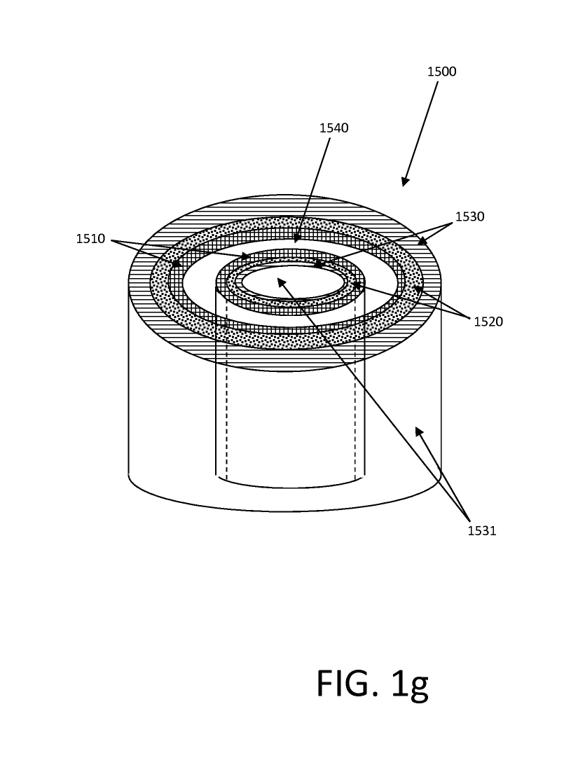

In some embodiments, the anode and cathode chambers are filled and remain static (i.e., no inflow or outflow of anode or cathode materials is present) during the relevant purification stage and during operation of the MFCs of interest. Once purification is complete, the chambers are emptied and refilled with new anode and cathode materials. An example of such a static MFC system is provided in FIG. 1a.

In some embodiments, the cathode and anode chambers are configured for continuous flow operation, such that the cathode material and the anode material flow through their respective chambers. An example of such a continuous flow MFC system is provided in FIG. 1b. In FIG. 1b, MFC 1000 is a conduit with chambers 1110 and 1120 separated by barrier 1100. Barrier 1100 (also shown in an expanded, cross sectional view) comprises ion exchange membrane 100, positive electrode 1130, and negative electrode 1140. Direction of anode and cathode material flow is indicated by arrows 1150. In the continuous flow MFCs of interest, wastewater is continuously renewed in one or both chambers. Furthermore, and as in the static MFCs of interest, in both chambers the wastewater is purified of one or more impurities and is simultaneously used as the anode or cathode solution.

Combinations of continuous flow and static operation can also be used. Thus, one of the chambers (i.e., anode or cathode) can be configured for continuous flow whereas the other chamber is configured for static operation.

In some embodiments, the anode chamber, cathode chamber, or both comprises an inlet for adding a wastewater treatment reactant (i.e., a material that purifies wastewater of an impurity via a chemical or physical reaction, such as an oxidant, flocculent, etc.). In some embodiments, such an inlet is a valve in the side of the electrode chamber. In other embodiments, the inlet is an open top to the electrode chamber (e.g., the top of the chamber has a door or is completely uncovered, such that the wastewater treatment reactant can be dropped into the chamber).

In some embodiments, the anode chamber comprises an anode outlet for extracting a purified wastewater material. By “purified” is meant that the material leaving the anode chamber contains less of one or more impurities compared with the material entering the anode chamber. Similarly, in some embodiments, the cathode chamber comprises a cathode outlet for extracting a purified wastewater material. Such outlets may be, for example, valves at the side or bottom of the chambers.

In some embodiments, the anode in the anode chamber and the cathode in the cathode chamber are placed in electrical communication to complete a circuit during operation of a MFC of interest. By “electrical communication” is meant to include direct, physical connection via a conductive material (e.g., wires, etc.), as well as instances where the two electrodes are connected to a load, such as opposite sides of a battery (e.g., where the MFC is used to charge the battery).

As described in more detail below, in some embodiments the anode chamber and cathode chamber of the MFCs of interest are positioned adjacent one another. By “adjacent” is meant that the contents of the chambers would mix but for the presence of a common barrier such as a shared wall or an ion exchange barrier (discussed below, also referred to herein as an “ion permeable membrane”). In such embodiments, the anode and cathode chambers are in ion communication, meaning that ions (e.g., protons and other cations) can flow between the chambers, such as through the ion exchange barrier. In other embodiments, the anode chamber and cathode chamber are not adjacent to one another. In such embodiments, the anode chamber and cathode chambers are in ion communication via a salt bridge, ion channel or other means for transfer of ions.

In some embodiments, an ion-exchange barrier is present and positioned between the anode chamber and the cathode chamber. The ion-exchange barrier is prepared from a material that is permeable to ions. For example, in some embodiments the ion-exchange barrier is a proton exchange membrane (PEM). Examples of PEMs include Nafion-117 (DuPont), CMI-7000 (Membranes International Inc.), polybenzimidazole, mixtures of polyethylene (PE) and poly(styrene-co-divinylbenzene), and the like. In some embodiments, the MFCs of interest are configured to operate as a membrane-less MFC.

In some embodiments, in addition to the two WWT materials, the MFCs of interest contain a plurality of electrodes. For example, in some embodiments, the MFCs of interest contain an anode and a cathode. In some embodiments, the electrodes used in the MFCs of interest are prepared from carbon-based materials. Examples of carbon based materials for electrodes include graphite (plates, rods, cloth, fibers, etc.), carbon fibers, carbon mesh, and the like. In some embodiments, the electrodes used in the MFCs of interest are metallic, including metal alloys. Examples of metals include platinum, copper, gold, silver, zinc, nickel, iron, cobalt, manganese, palladium, rhodium, ruthenium, lead, tin, and alloys and combinations thereof.

In some embodiments, a mediator is used to aid in transfer of electrons to the anode electrode. Examples of mediators include compounds such as potassium ferricyanide, thionine, pyocyanin, or neutral red. Alternatively, the MFCs of interest can employ mediators used by the bacteria present in the WWT materials. When a mediator is necessary and present, combinations of mediators can be used. In some embodiments, a mediator is not necessary and is not employed (i.e., the MFC operates as a mediator-less MFC). In some embodiments, the MFCs of interest are configured to operate without a mediator (i.e., mediator-less operation).

In some embodiments oxygen gas and/or an oxygen-containing gas mixture such as air is added (e.g., bubbled) into the solution in the anode or cathode chamber. In some embodiments, oxygen is added to boost the oxidation of certain WWT material components, such as dissolved iron, etc.

In some embodiments, a disinfectant is used in one stage of the water treatment process, such as second tertiary treatment stage 41 shown in FIG. 2a. In WWT methods, the disinfectant is used toward the end of the treatment process in order to kill any living organisms (bacteria, protozoans, etc.) present in the water. In some embodiments of the WWT methods of interest, the disinfectant serves the same function and also serves as an oxidizing solution suitable for the cathode solution. Disinfectants (also referred to herein as oxidizers) can be a solid material that is partially or completely insoluble in water, a liquid material that is partially or completely miscible with water, or a gaseous material. General examples of suitable disinfectants include peroxides (e.g., alkali or alkaline earth peroxides), halogenated N-halamines, persulfates, perborates, and the like. Some specific examples of disinfectants suitable for use in the MFCs of interest include sodium hypochlorite, chloramine, hexaferrocyanate, hydrogen peroxide, sodium peroxide, peroxomonosulfate, peroxodisulfate, peroxymonosulfuric acid, peroxydisulfuric acid, sodium perborate, trichloroisocyanuric acid (C₃N₃O₃Cl₃), 1,3-dichloro-5,5-dimethylhydantoin, and the like.

In some embodiments, an organic material is added to the anode or cathode chamber. The organic material serves as a fuel capable of sustaining or helping the sustenance of microbial populations. Examples of fuel sources include saccharides such as glucose, acetate, and the like.

In some embodiments, conductive carbon pebbles are added to the MFCs. For example, carbon pebbles can be added to the cathode chamber. Such materials may be added, for example, in order to increase the surface area of the electrode. Such materials may also or alternatively be added to absorb dissolved contaminants or other dissolved materials at one stage in the WWT process, particularly where such contaminants or other materials are undesirable for a subsequent stage in the treatment process. In some embodiments, such materials have high surface areas and are conductive (e.g., have an electrical conductivity of greater than about 1 S/cm, or greater than about 10 S/cm, or greater than about 100 S/cm, or greater than about 1000 S/cm), such that the material serves as an absorbent and/or an electrode material.

### MFC Layouts for WWTFs

In some embodiments, a WWTF is designed such that the materials from two treatment stages are adjacent one another. In some embodiments, more than two treatment stages are adjacent one another (e.g., three stages are adjacent, or more than one pair of stages are adjacent). In some embodiments, a WWTF is designed to maximize the number of treatment stages that are adjacent to other treatment stages.

An example of a WWTF design according to the disclosure is provided in FIG. 2b. First secondary treatment stage 30 and second tertiary treatment stage 41 are adjacent and are separated by ion exchange membrane 100. Thus, stage 30 and stage 41 together form a MFC, with stage 41 (having the higher oxidizing potential) as the cathode chamber/material and stage 30 as the anode chamber/material. Also in FIG. 2b, sludge return tanks 33 and second tertiary treatment stage 41 are adjacent and are separated by ion exchange membrane 110. Thus, stage 33 and stage 41 together form a MFC, with stage 41 as the cathode chamber/material and stage 33 as the anode chamber/material. Similarly, sludge return tanks 33 and first tertiary treatment stage 40 are adjacent and are separated by ion exchange membrane 120. Similarly, first tertiary treatment stage 40 and second secondary treatment stage 31 are adjacent and are separated via ion exchange membrane 130.

In some embodiments, the anode chamber is a stage in a wastewater treatment process, and is in fluid communication with a prior stage of the process, a subsequent stage of the process or both. In some embodiments, the cathode chamber is a stage in a wastewater treatment process, and is in fluid communication with a prior stage of the process, a subsequent stage of the process or both. For example, in some embodiments, the inlet to the anode chamber is in fluid communication with a prior stage in the treatment process (i.e., where the wastewater contains one or more impurities that are removed and are not present in the material entering the anode chamber). In some embodiments, the anode outlet is in fluid communication with a subsequent stage in the treatment process (i.e., where an additional impurity is removed from the wastewater material leaving the anode chamber). Similarly, in some embodiments, the inlet to the cathode chamber is in fluid communication with a prior stage in the treatment process (i.e., where the wastewater contains one or more impurities that are removed and are not present in the material entering the cathode chamber). In some embodiments, the cathode outlet is in fluid communication with a subsequent stage in the treatment process (i.e., where an additional impurity is removed from the wastewater material leaving the cathode chamber). The terms “prior” and “subsequent” can, for example, refer to the order of treatment stages shown in FIG. 2a. Thus, for example, in some embodiments the anode is second secondary treatment stage 31 and has an anode outlet that is in fluid communication with first tertiary treatment stage 40 and an anode inlet that is in fluid communication with first secondary treatment stage 30. Also for example, the cathode is second tertiary treatment stage 41 and has a cathode inlet in fluid communication with first tertiary treatment stage 40 and a cathode outlet in fluid communication with storage unit 50. Other such combinations and connections will be apparent by reference to FIG. 2a. It will be appreciated, of course, that FIG. 2a is only one representation of a wastewater treatment facility, and that other configurations are possible. The terms “prior” and “subsequent” will have similar meanings for alternative wastewater treatment facility configurations.

### Methods of Operation

In some embodiments, the MFCs of interest are integrated into a WWTF. By this is meant that a WWTF is designed and operated so as to create MFCs that operate concurrently with the water treatment stages. For example, in some embodiments, the various stages of wastewater treatment are configured such, in at least one instance, two water treatment stages are physically adjacent one another. In this way, the material present at the two stages are able to form the anode and cathode materials of a MFC. In some embodiments, more than one MFC is created in the same WWTF, such as two or three or four or more MFCs. Each MFC is formed by two WWT stages and a barrier therebetween, such as an ion permeable membrane.

In some embodiments, therefore, an MFC is created whereby the cathode chamber is a storage tank for one of the stages in a WWTF. For example, the cathode chamber is the storage tank(s) for the second tertiary treatment stage of a WWTF. Also for example, the cathode chamber is the storage tank(s) for the first tertiary treatment stage of a WWTF. Also for example, the cathode chamber is the storage tank(s) for the first secondary treatment stage of a WWTF. Also for example, the cathode chamber is the storage tank(s) for the second secondary treatment stage of a WWTF. Also for example, the anode chamber is the storage tank(s) for the sludge return stage of a WWTF. Also for example, the anode chamber is the storage tank(s) for the first secondary treatment stage of a WWTF. Also for example, the anode chamber is the storage tank(s) for the second secondary treatment stage of a WWTF. Also for example, the anode chamber is the storage tank(s) for the first tertiary treatment stage of a WWTF. Any combination of the above designations can be used, provided that the cathode chamber and the anode chamber contain materials of different composition (and can therefore create an electrical potential in an MFC).

In some embodiments, the MFCs of interest provide at least a portion of the energy required for the treatment of the wastewater materials used in the MFC. For example, in some embodiments the energy generated by a MFC located in a WWTF is used directly in one of the purification stages of the WWTF, or the energy is stored in an energy storage device and used at a later time in one of the purification stages of the WWTF. In some embodiments at least 1% of the energy required by a WWTF is generated by a MFC designed according to the disclosure, or at least 10% of the energy, or at least 20% of the energy, or at least 30% of the energy, or at least 40% of the energy, or at least 50% of the energy. In some embodiments less than 1% of the energy demand is generated by a MFC, but the energy generated is sufficient to provide a feasible auxiliary source.

In some embodiments, the cathode material and the anode materials (which may be collectively referred to herein as “electrode materials”) are materials from different stages in a WWT process, and, as stated herein, the MFCs of interest are integrated with the WWT process. Accordingly, the cathode material is fed to the cathode compartment, allowed to remain in the cathode compartment for a first period of time, and then removed from the cathode compartment. Similarly, the anode material is fed to the anode compartment, allowed to remain in the anode compartment for a second period of time, and then removed from the anode compartment. The first and second periods of time may be the same or may be different, and may be independently selected to optimize a number of variables (e.g., current output of the MFC, purification process parameters, length of time required to purify the electrode materials, etc.). Such times may be less than 30 min, or less than 1 hour, or less than 6 hours, or less than 12 hours, or less than 24 hours, or greater than 24 hours. In continuous flow designs, the electrode materials may be in the electrode compartments (i.e., anode compartment and cathode compartment) for less than 10 min, or less than 5 min, or less than 2 min, or less than 1 min, or less than 30 seconds.

In some embodiments, during all or a portion of the time that electrode materials are in the electrode compartments, the MFCs produce an electrical current output. As mentioned above, such output can be stored or can be used to provide part or all of the power needs in the WWT process. Alternatively, the power output can be fed to an electricity grid such as a municipal grid. Also during all or a portion of the time that electrode materials are in the electrode compartments, the electrode materials undergo treatment such as one or more of the stages in a conventional WWT process. Thus, when an electrode material exits an electrode compartment, it is purified relative to the material when it entered the electrode compartment. For example, cathode material that is removed from the cathode compartment after the first period of time mentioned previously is purified relative to the cathode material as it enters the cathode compartment (i.e., prior to the first period of time). Similarly, anode material that is removed from the anode compartment after the second period of time is purified relative to the anode material as it enters the anode compartment (i.e., prior to the second period of time).

In the context of this disclosure, the term “purified” includes the complete or partial removal of any one or more impurities present in a material, wherein “impurities” includes any material that is undesired and/or any material that is different from the material of the target composition. Common water impurities include sewage components (i.e., feces, microbes, etc.), municipal and agricultural runoff materials (e.g., fertilizers, animal waste products, etc.), and other organic or inorganic materials that are toxic, unsanitary, or otherwise undesirable in treated water.

For example, when the cathode compartment is the disinfecting stage of a WWT process (i.e. the second tertiary treatment stage), the cathode material is a disinfecting mixture. The disinfecting mixture is formed by combining the output of the first tertiary treatment stage (i.e., the filtered activated sludge) with a disinfectant. The output of the disinfecting stage, i.e., the output taken from the cathode compartment, is a purified water product. The purified water product is purified compared with the filtered activated sludge. In particular, the purified water product contains a lower concentration of living organisms compared with the filtered activated sludge.

Substances that can be removed during any purification identified herein and associated with a MFC of interest include the common water impurities identified above. In addition, purification can involve removal of an unpleasant color or odor from the wastewater.

The MFCs of interest may further be configured and designed for use with (or for use as) portable water treatment devices. In some such embodiments, the MFC includes two chambers (configured for static operation or continuous flow) that can accept materials from a WWTF or from another source of wastewater (e.g., municipal sewage sources, animal sewage, farm runoff, etc.), and can subsequently return the materials to the WWTF or to another facility.

The approach described here can be implemented in devices that use flowing oxidants but are not necessarily used for water treatment purposes. For example, the methods of interest could be used for other microbial fuel cell systems such as sediment-anode fixed approaches. Such devices, for example, could use a run-off oxidant as part of the microbial fuel cell. Examples of such devices can be found, for example, in U.S. Pat. No. 7,767,323, the contents of which are incorporated herein by reference.

As mentioned herein, in some embodiments, the MFCs of interest are configured for continuous or semi-continuous flow of one or both of the WWT materials (i.e., cathode solution and/or anode solution). FIG. 1b provides a schematic diagram illustrating one embodiment of such a device. Device 900 contains chambers 910 and 920 separated by barrier 930. Barrier 930 comprises negative electrode 940, positive electrode 950, and ion exchange membrane 960. Two embodiments of barrier 930 are shown in expanded, cross-sectional views to more clearly show the various components. Barrier 930a is a simple lamination of flat electrodes and a membrane. Barrier 930b illustrates a means for increasing the surface area of the barrier by including folds and indentations. In operation, one WWT material is flowed through chamber 910 and a different WWT material is flowed through chamber 920. The arrows show an example of the direction of flow of the two WWT materials. The device can be configured such that the WWT materials continuously flow through chambers 910 and 920, or semi-continuously flow through such chambers (e.g., material flows in, is held for a period of time, and then flows out to be replaced with fresh material).

FIG. 1c illustrates another embodiment of a continuous or semi-continuous flow MFC. Device 901 contains multiple barriers 931 (three are shown). An expanded, cross-sectional view of barrier 931 (indicated by dashed arrow) shows more clearly the configuration of negative electrode 940, positive electrode 950, and ion exchange membrane 960. Again, the arrow indicates an example of the direction of flow of a WWT material. Device 901 provides increased surface area of the electrodes compared with a single, flat barrier.

In some embodiments, excess oxidizer is recovered from the MFCs of interest and diverted to an additional energy production device. In some such embodiments, the oxidizer is a solid material. Excess oxidizer is conveniently recovered when such oxidizer is a solid, and the recovery process can be accomplished by a variety of means (e.g., filtration, gravity separation, etc.). Excess liquid oxidizers can also be recovered and used in additional energy production devices, particularly when such recovery is economically viable. In some embodiments, a single oxidizer storage facility is used to provide oxidizer to the MFC and to the additional energy production device such as a galvanic cell. FIG. 1d provides a block diagram illustrating an embodiment of this concept. Oxidizer is stored in storage facility/container 1200, and provided to stage 1220 of the water purification process (e.g., second tertiary treatment stage 41 in FIG. 2a) via conduit 1205. Wastewater is also provided to stage 1220 via conduit 1215. In stage 1220, the oxidizer is formed, if necessary (e.g., if it is supplied in a pre-reactive form), and carries out oxidation/disinfection on the wastewater. Disinfected water continues on in the process via conduit 1225 into covered storage or additional treatment if necessary. Excess solid oxidizer is then removed from stage 1220 via conduit 1235 and is provided to an additional energy production device such as galvanic cell 1230. Examples of such additional energy production devices include those described in U.S. Pat. Nos. 7,931,978 and 7,855,015, as well as US Patent Application Publication No. 2010/0216038, the entire disclosures of which are incorporated herein by reference. An alternative configuration for embodiments that “reuse” excess oxidizer is shown in FIG. 1e. Device 1300 contains channels 1310 and 1320 separated by PEM barrier 1330. Oxidizer (shown as small round particles) is fed into side 1320 of device 1300 via hopper 1340. Side 1320 is also supplied with wastewater that requires disinfecting. Side 1310 is supplied with a second WWT material. The disinfected water leaves device 1300 for storage or further treatment. Within side 1320, the disinfectant particles sink via gravity through the WWT material and to the bottom of the device, all the while acting to disinfect the WWT material flowing through side 1320. The cutout section of device 1300 shows this downward migration of disinfectant particles. When the disinfectant particles reach the bottom of side 1320, they are extracted and transported to an additional energy production device, such as battery 1350 shown in FIG. 1e. For example, battery 1350 could be a metal anode device. Alternatively, the excess oxidizer from device 1300 can be used in a hydrogen gas and PEM fuel cell.

In an alternative configuration of the device in FIG. 1e, an aquatic sediment is provided to channels 1310 and 1320. Any aquatic sediments may be used so long as they produce an electrical potential in the device. Such a configuration would not necessarily produce a purified water product. Alternatively, one channel in FIG. 1e can be fed with a WWT material and the other can be fed with a material not from a WWT facility (e.g., an aquatic sediment).

FIG. 1f illustrates an example device that can be immersed in tanks of current WWT facilities to harvest energy using WWT materials. Device 1400 offers planar surface 1411 of anode electrode 1410. In operation, planar surface 1411 faces a WWT material (e.g., a microbial-containing material), such as by immersing device 1400 in the WWT material. Ion exchange membrane 1420 separates anode 1410 from cathode electrode 1430. Adjacent to cathode 1430 is storage area 1440, where a packaged oxidizer is stored. In addition to the oxidizer, depolarizers and/or agitators are included in storage area 1440 as needed. Alternatively, storage area 1440 may be a region whereby the oxidizer is dispensed continuously or semi-continuously into the surrounding WWT material.

FIG. 1g illustrates another example device that can be immersed in tanks of current WWT facilities. Device 1500 is a double roll of the electrode-membrane. The double-roll configuration provides increased surface area. Positive electrodes 1510 and negative electrodes 1530 are separated by ion exchange membranes 1520. Surfaces 1531 are configured to face the WWT material (e.g., microbial-containing effluent, etc.). Region 1540 contains packaged oxidizer and other materials as needed and as described above in FIG. 1f.

Devices similar to those shown in the figures (e.g., FIGS. 1f and 1g) can be employed to use the microbial communities of digester septic tanks in additional MFC designs according to this disclosure. As describe herein, such devices can be used for portable MFCs that use wastewater as the anode solution, cathode solution, or both.

It will be appreciated that, in the figures for continuous and semi-continuous flow devices, the arrows indicating directional flow of WWT material are merely exemplary. It is also possible for some or all of the arrows to be reversed.

In some embodiments, increase the potential output of the MFCs of interest is directly related to minimizing the internal cell resistance. For example, improvements to the systems of interest include decreasing the membrane thickness and increasing the electrode areas. As described above, the schematic in FIG. 2b shows one embodiment of a water reclamation plant design with various effluents side by side to permit the straightforward implementation of electrode insertion and energy harvesting. This same approach can be used for portable water treatment devices.

It is to be understood that while the invention has been described in conjunction with the preferred specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains.

### EXAMPLES

St. Petersburg, Fla. has four water reclamation plants (WRP), each having the same basic treatment process. This process involves three stages, primary, secondary and tertiary treatment, as described hereinabove with reference to FIG. 2a. The samples for the examples set forth below were collected from the aeration tanks, secondary clarification tanks, filtration tanks and chlorination disinfection tanks at the Albert Whitted (Southeast) WRP.

For this study, samples were collected at least once or twice a week over a three month period. After collection, the samples were placed in fuel cell setups, and either polarographic-type results were obtained, or the cell potential as a function of time was recorded. The polarographic type curves were obtained from the cells periodically using resistors with values ranging from 200 kΩ to 47Ω depending on the observed output voltage. Polarigraphic curves (cell potential vs. current) were obtained pairing various effluents collected from the water treatment plant, and also pairing some of these effluents with other types of oxidizers (all with the capability of providing chemical disinfection). Voltage vs. time graphs were obtained for selected results to demonstrate the long-term capacity of producing energy with the aforementioned approach. In the cases where the potential as a function of time was recorded, the solution levels were re-filled intermittently (generally twice a week) to account for evaporation.

Fuel cell-like containers were fabricated by cutting a plastic beaker in half and gluing an ion-exchange membrane between the halves, which then formed the two galvanic compartments (i.e., cathode compartment and anode compartment). Leakage between compartments or outside the cells was avoided by applying two successive coatings of a spray-on commercial glue (FC-77 from Dupont) and by cutting the membrane with a larger dimensions than the actual opening of the beakers' halves. Most cells were fabricated and tested using the CMI-7000 membrane, which costs significantly less than the Nafion-117 membrane.

Three basic types of electrodes where tested with the different solutions: carbon mesh, carbon foils and a silver mesh electrode. The carbon foil fabricated electrodes were first coated with a metal (gold or palladium) and a titanium adhesion layer, as has been reported in literature. The electrodes were fabricated by using a thin silver wire which was “weaved” into the upper part of the electrode. Silver was used, as copper wires used in first attempts experienced oxidation. After the silver was mechanically attached to the electrode, a coating of conductive carbon paint was applied to the wire-electrode interface. When dried this layer of carbon paint provided additional mechanical attachment for the silver lead. The electrodes were placed as close as possible to the ionic exchange membrane.

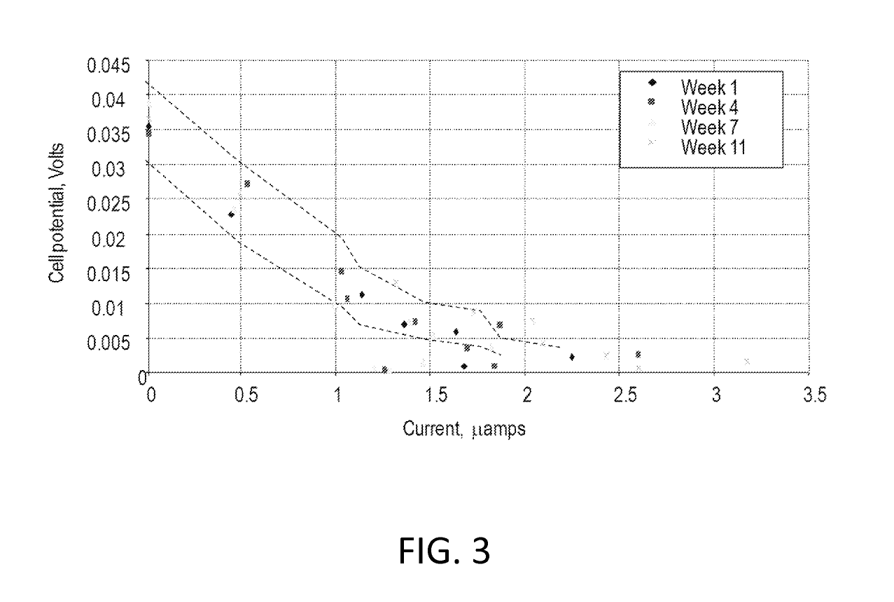

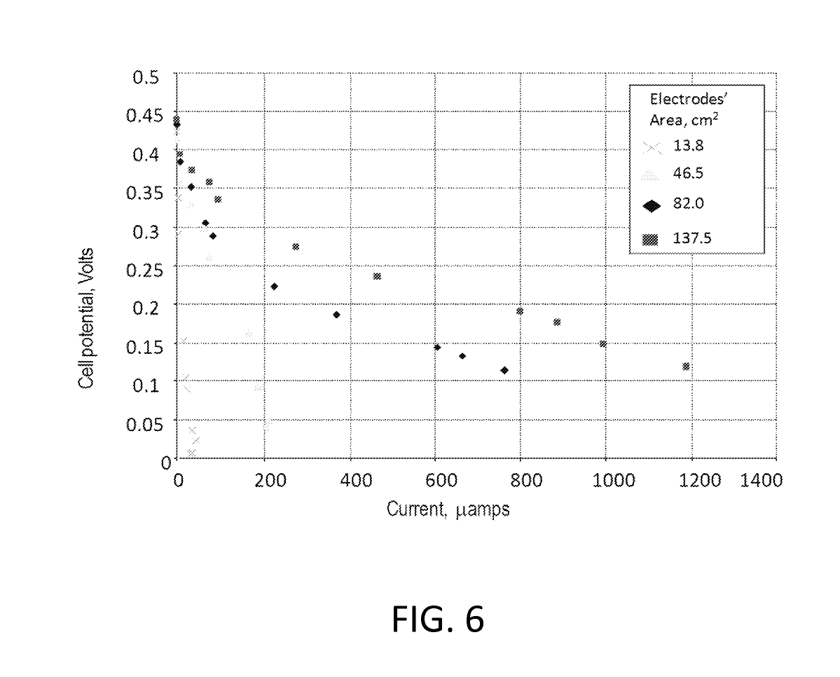

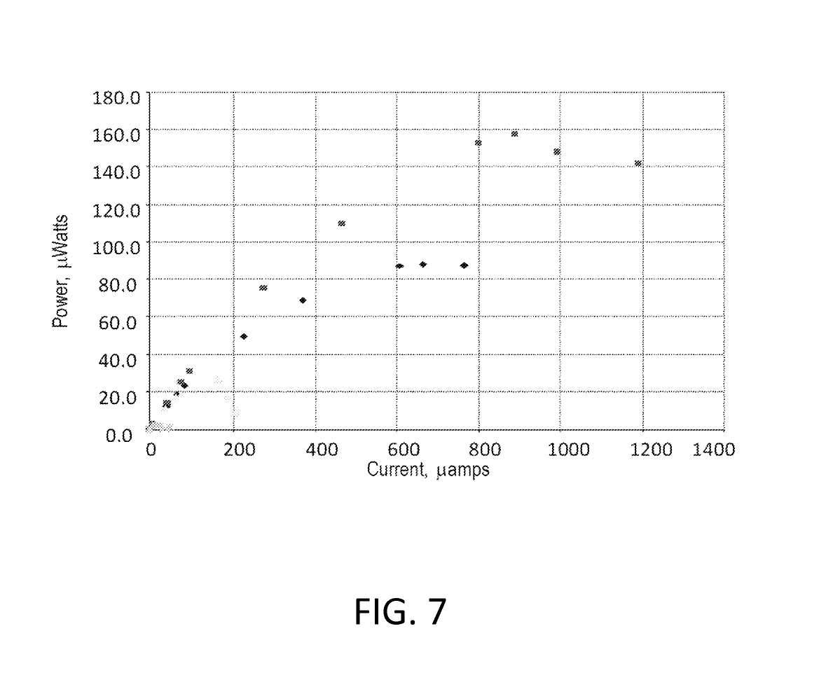

The results were obtained using small fuel cells (46.5 cm² of electrode area) with CMI-ion exchange membranes, fabricated as described above (unless otherwise indicated). FIGS. 3-5 show polarographic-type curves obtained from pairing various solutions from the water treatment plant. FIGS. 6 and 7 show polarographic-type curves obtained from two effluents from the water treatment plant in cells of different sizes.

For FIG. 3, the cathode solution was a WWTF sample of sodium hypochlorite from disinfection tank. The anode solution was a WWTF sample from filtration tank. The electrodes were carbon mesh (area=46.5 cm²). Dashed lines are confidence intervals calculated as the mean values of cell and current±twice the standard deviation of the replicates.

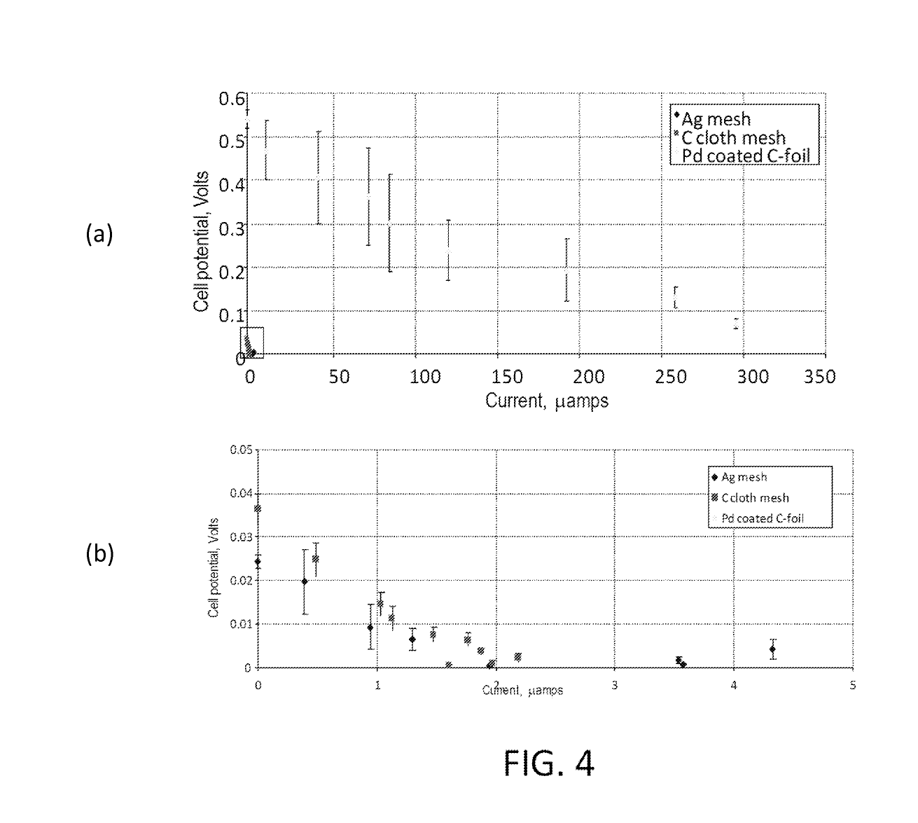

For FIG. 4a, the cathode solution was a WWTF sample of sodium hypochlorite from disinfection tank. The anode solution was a WWTF sample from filtration tank. The anode electrode was carbon mesh (electrode area=46.5 cm²). Error-bars show the maximum and minimum values obtained from experimental runs. FIG. 4b shows an expanded view of the graph from FIG. 4a (near the origin, boxed portion).

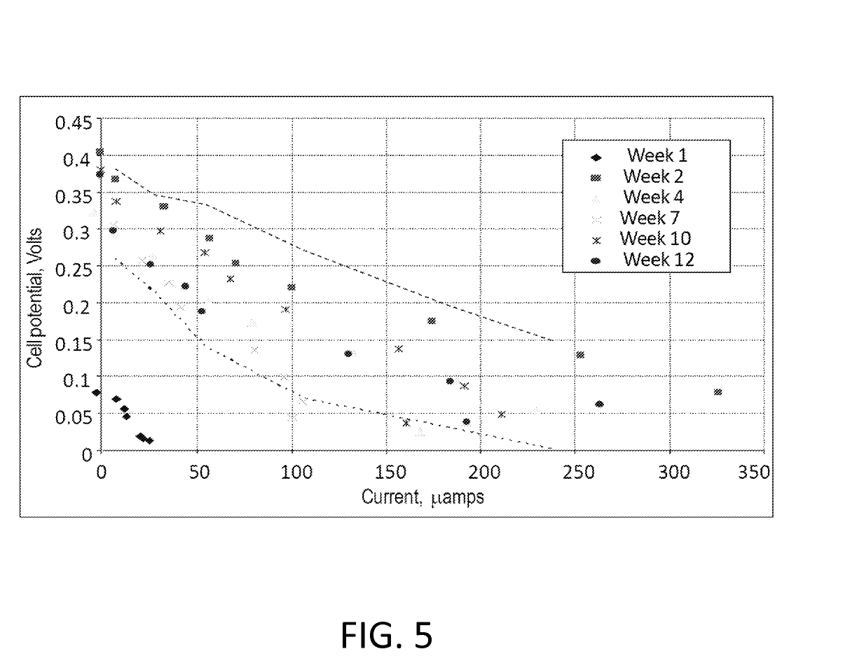

For FIG. 5, the cathode solution was a WWTF sample from aerated activated sludge tank. The anode solution was a WWTF sample from the sludge return tank. The electrodes were carbon mesh (area=46.5 cm²). Dashed lines are confidence intervals calculated as the mean values of cell and current±twice the standard deviation of the replicates taken after Week 2.

For FIG. 6, the cathode solution was a WWTF sample from aerated activated sludge tank. The anode solution was a WWTF sample from the sludge return tank. The electrodes were carbon mesh (area=46.5 cm²).

In order to perform a size extrapolation from the data presented in FIGS. 3-7, a mathematical model was utilized. In the past, estimates of cell potential were reported using a predictive approach based on first principles for cells with output potentials under load (Vload) which is limited by ion exchange rates (diffusion). The approach is described in the literature by the following relationship:

$${V}_{load} = [ {V}_{oc} + ( \frac{D}{μ} ) ln ( \frac{d}{ζ e μ A} ) ] - ( \frac{D}{μ} ) ln ( {R}_{load} ) \qquad ( 1 )$$

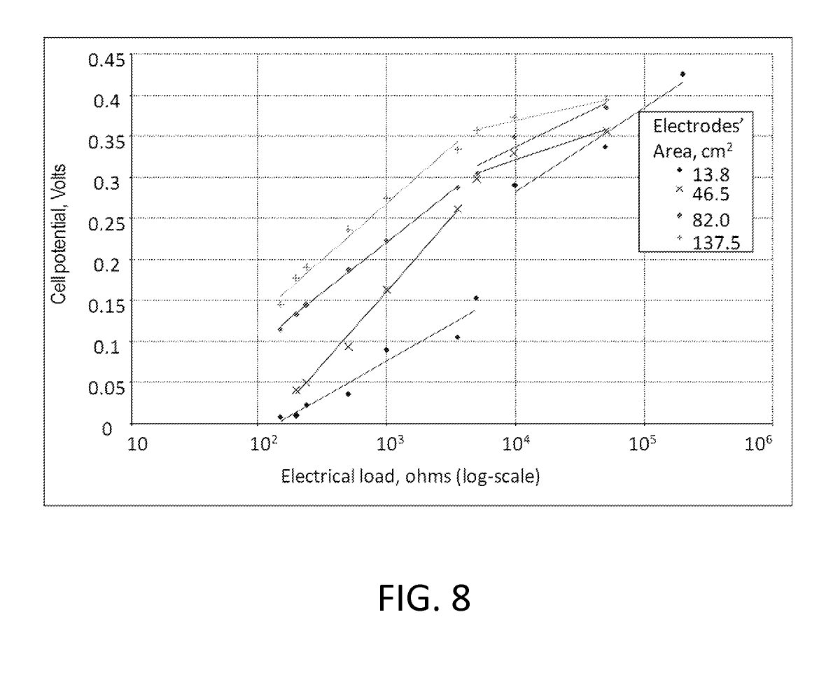

In order to establish the validity of the equation, the logarithm of the load (ln(R_{load})) vs. the loaded potential (V_{load}) can be plotted. If the experimental outputs of the cells follow the mathematical relationship represented by equation 1, ln(R_{load}) vs. loaded potential, V_{load} should approximate a straight line. FIG. 8 shows this linear relationship for our fuel cell data.

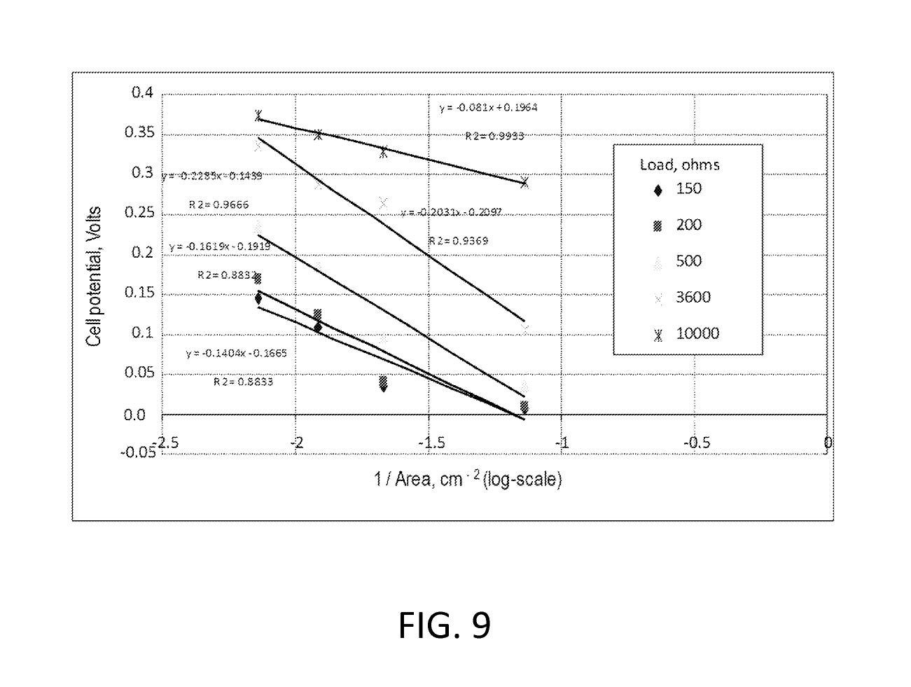

FIG. 9 shows the log(1/A) vs. V_{load} at various loads. As expected the relationship is also linear. The fitted straight lines can be used to extrapolate data to infer the approximate potential under load of larger cells.

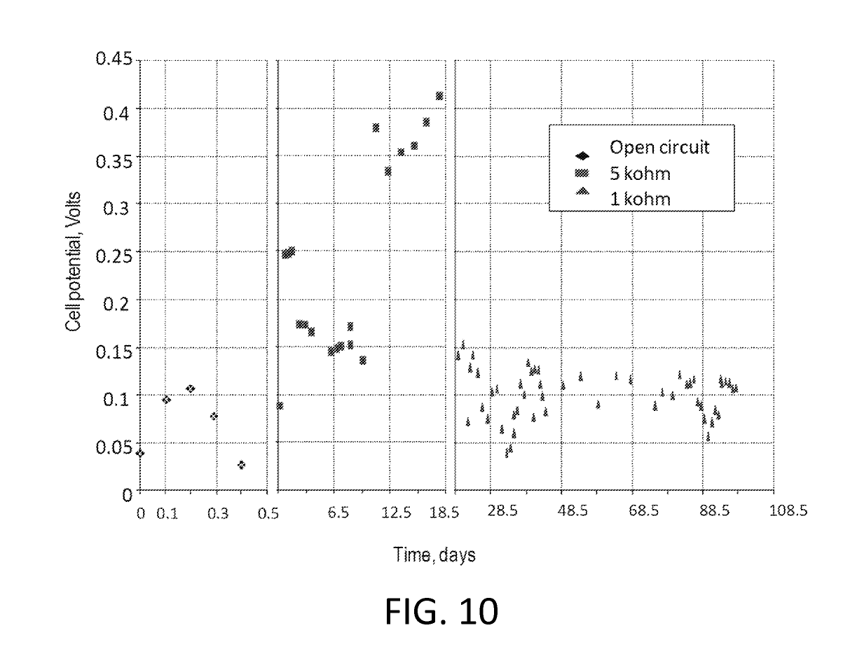

The cell potential for small cells (46.5 cm² of electrode area) was also recorded as a function of time for the results obtained from pairing the solutions described above. In FIG. 10 we only report the results of pairing solutions with bioactive sludge. The cell potential was relatively constant over the time tested. For FIG. 10, the cathode solution was a WWTF sample from aerated activated sludge tank. The anode solution was a WWTF sample from the sludge return tank. Electrodes were carbon mesh (area=46.5 cm²).

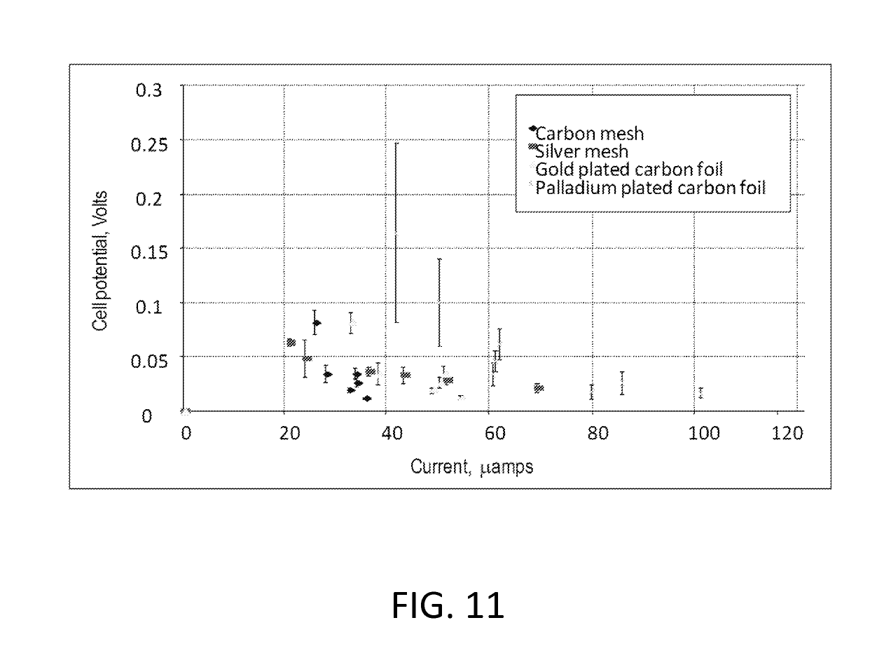

Other disinfectants are known to have the ability to disinfect water samples. Hydrogen peroxide is used for disinfection of water in European countries; however, FIG. 11 shows that direct use of this material provides relatively low currents. For FIG. 11, the cathode solution was 3% solution of H₂O₂₍ₗ₎ in water. The anode solution was a WWTF sample from filtration tank. The anode electrode was carbon mesh (area=46.5 cm²).

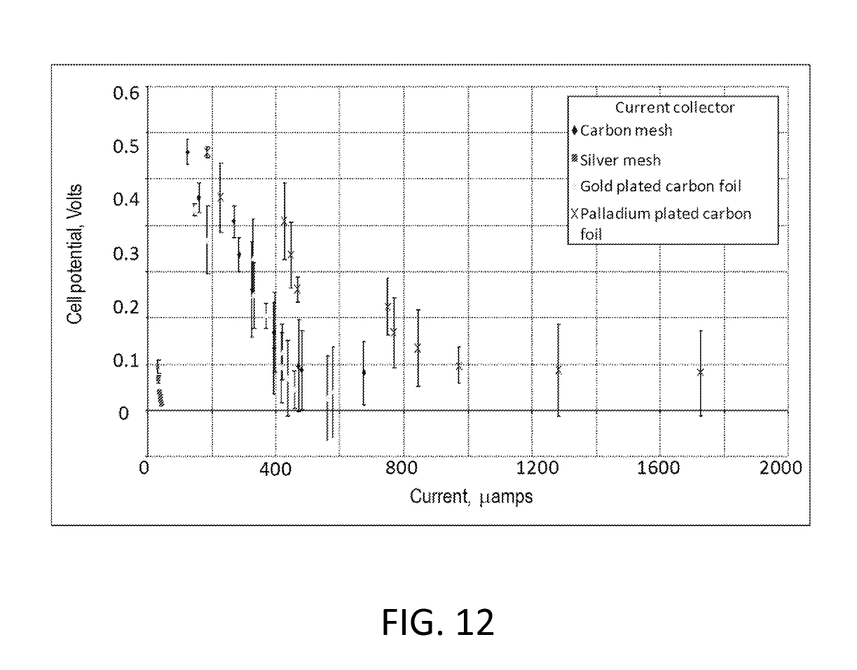

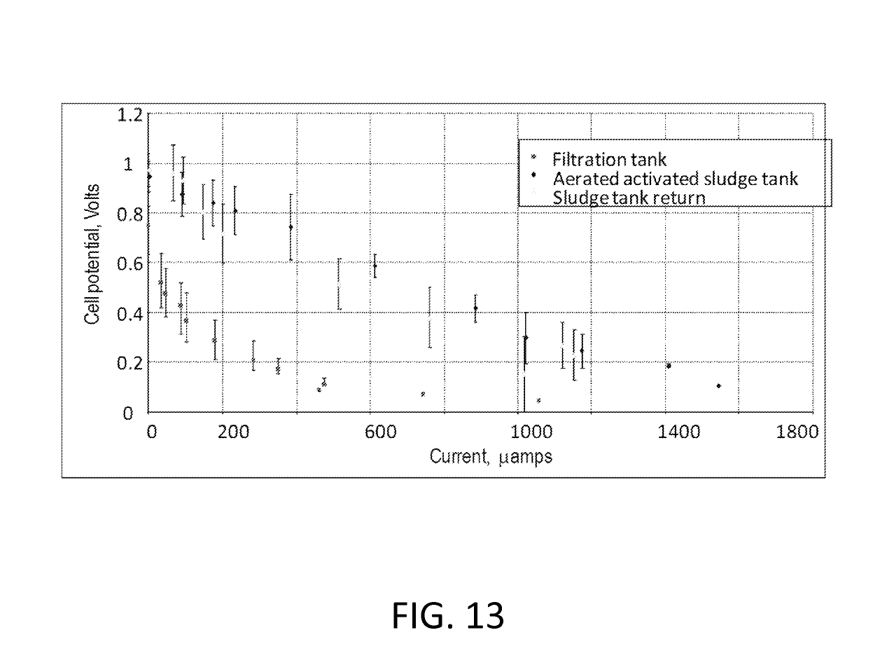

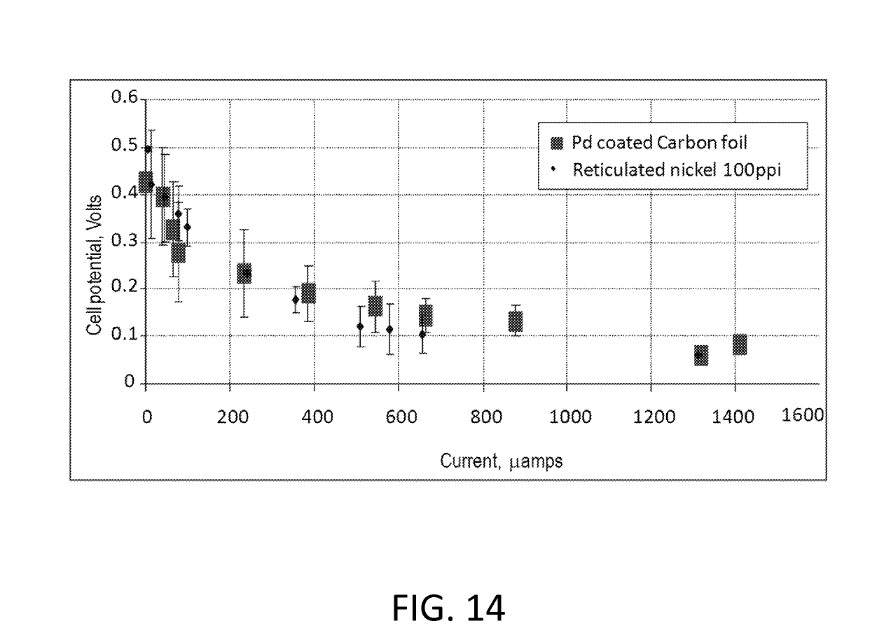

Two other solid materials were also tested: Trichloro-s-triazinetrione (C₃N₃O₃Cl₃), a chemical commonly utilized for pool disinfection, and sodium peroxide, a chemical known to release hydrogen peroxide. Results using various current collectors/catalytic surfaces are shown in FIGS. 12-14 (water was used as the anode). For FIG. 12, the cathode solution was 5% mixture of C₃N₃O₃Cl₃₍ₛ₎ in water. The anode solution was a WWTF sample from filtration tank. The anode electrode was a carbon mesh (area=46.5 cm²). For FIG. 13, the anode electrode was carbon mesh (area=46.5 cm²). The cathode solution was 10% mixture of C₃N₃O₃Cl₃ in water. The anode solutions were various (three samples from the WWTF). The catalytic surface area was 46.5 cm². For FIG. 14, the cathode solution was 10% mixture of Na₂O₂₍ₛ₎ in water, and the anode solution was aerated activated sludge.

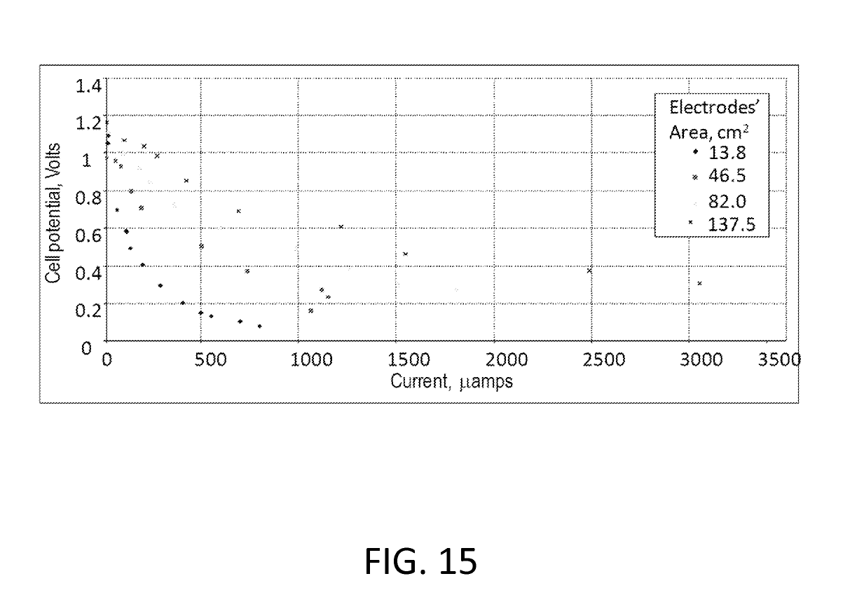

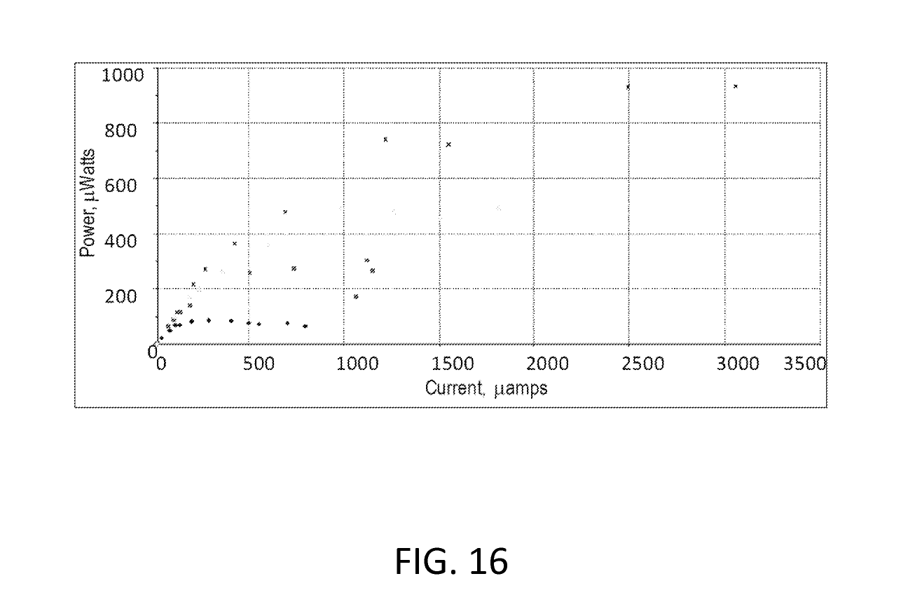

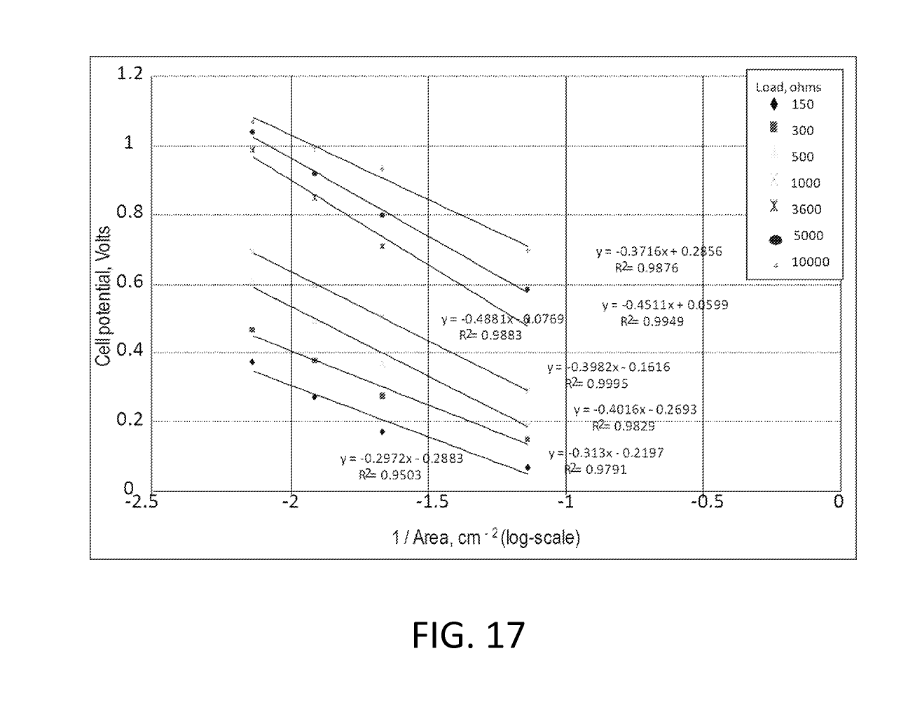

The solid oxidizers were also paired with various effluents from the water treatment plant (FIG. 15) and tested in various size cells (FIG. 16). A similar analysis as described in results section 1 was performed for extrapolation (FIG. 17). For FIG. 15, the cathode solution was 10% mixture of C₃N₃O₃Cl₃₍ₛ₎ in water. Cathode current collector was a palladium coated carbon foil. The anode solution was a continuously aerated WWTF sample from the aerated activated sludge tank. The anode electrode was carbon mesh.

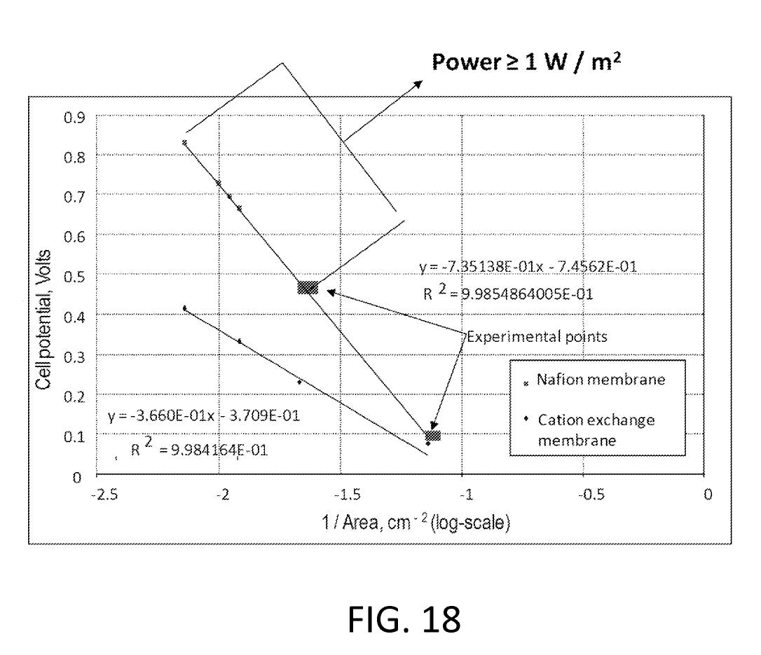

In order to increase the attainable potential, and form a basis of comparison for attainable energy, the Pd-catalytic surface was used with solid C₃N₃O₃Cl₃. Nafion membranes were used as the ion-exchange medium. In order to increase the conductivity (and possibly the catalytic activity of the cathode electrode), carbon pebbles were added to the cathode side. In this case, only two cell sizes were fabricated, but theoretical data were generated using Equation 1 and linear extrapolation. The results are shown in FIG. 18. Previous experiments showed that the conductivity of the CMI membranes produced half the voltage of those with the Nafion membrane, and results from these experiment using CMI membranes were calculated using this assumption. The constants for the linear fit obtained were similar to those shown in FIG. 17. For FIG. 18, the graph shows Cell potential vs. the reciprocal of electrode's area (log-scale) obtained by extrapolating the shown “real data” from microbial fuel cells of various sizes. Data was obtained using a 47-ohm load. The real data points were obtained by using a cell set-up using Nafion 117 as the Ion-exchange membrane. The cathode solution was 45% mixture of trichloro-s-isocyanuric acid and activated carbon pebbles (20%) in water (mixing achieved by recirculation pumping). The cathode current collector was Pd-coated carbon foil. The anode solution was a WWTF sample from aerated activated sludge tank. The anode electrode was carbon mesh.

What is claimed is:

1. A microbial fuel cell (MFC) comprising:
a cathode positioned in a cathode compartment;
an anode positioned in an anode compartment, wherein the anode is in electrical communication with the cathode;
an anode inlet for providing a first material to the anode compartment;
a cathode inlet for providing a second material to the cathode compartment;
an optional anode outlet for removing a treated first material from the anode compartment; and
an optional cathode outlet for removing a treated second material from the cathode compartment, provided that at least one of the optional anode outlet and the optional cathode outlet is present,
wherein the first material is a wastewater composition comprising one or more impurities, and the second material is a wastewater composition comprising one or more impurities and the first and the second materials differ in composition.

2. The MFC of claim 1, wherein at least one of the anode inlet and anode outlet is in fluid communication with a first treatment stage at a wastewater treatment facility, and wherein at least one of the cathode inlet and cathode outlet is in fluid communication with a second treatment stage at the wastewater treatment facility.

3. The MFC of claim 1, wherein the MFC comprises an ion exchange membrane disposed between the cathode compartment and the anode compartment.

4. The MFC of claim 1, wherein at least one of the anode compartment and the cathode compartment are in fluid or solid communication with an inlet for providing a treating material.

5. The MFC of claim 4, wherein the treating material is selected from a disinfectant, an oxidant, and a microbe.

6. The MFC of claim 1, wherein the first material and second material are wastewater compositions from a source selected from a human wastewater treatment facility, an industrial wastewater treatment facility, and a livestock wastewater treatment facility.

7. The MFC of claim 1, wherein the first and second materials are independently selected from a sludge return, an activated sludge, a filtered activated sludge, a clarified activated sludge, and a disinfecting mixture.

8. The MFC of claim 7, wherein the disinfecting mixture comprises a peroxide, a halogenated halamine, a persulfate, a perborate, or a combination thereof.

9. The MFC of claim 1, wherein at least one of the anode compartment and the cathode compartment comprises an inlet for supplying oxygen or an oxygen-containing gas.

10. The MFC of claim 1, further comprising an outlet for extracting a purified water product from the anode compartment, an outlet for extracting a purified water product from the cathode compartment, or both.

11. A method for treating wastewater, the method comprising:
supplying a first wastewater material to a cathode compartment, and maintaining the first wastewater material in the cathode compartment for a first predetermined period of time; and
supplying a second wastewater material to an anode compartment, and maintaining the second wastewater material in the anode compartment for a second predetermined period of time;
wherein the cathode compartment comprises a cathode, and the anode compartment comprises an anode, and wherein the anode and cathode are in electrical communication.

12. The method of claim 11, wherein the anode compartment and cathode compartment are separated by an ion permeable membrane.

13. The method of claim 11, wherein the first and second wastewater materials are from a wastewater treatment facility treating wastewater generated by humans, livestock, or a combination thereof, and wherein the first and second wastewater materials are independently selected from a sludge return, an activated sludge, a filtered activated sludge, a clarified activated sludge, and a disinfecting mixture.

14. The method of claim 11, wherein the first wastewater material is purified during the first predetermined period of time, and the second wastewater material is purified during the second predetermined period of time.

15. The method of claim 11, comprising obtaining a first purified wastewater material from the cathode compartment after the first predetermined period of time and obtaining a second purified wastewater material from the anode compartment after the second predetermined period of time.

16. The method of claim 12, wherein an electrical current is present between the anode and the cathode during the first predetermined period of time or second predetermined period of time.

17. A method for generating energy in a microbial fuel cell (MFC), the method comprising:
supplying a first material from a wastewater treatment facility to an anode compartment, wherein the anode compartment comprises an anode; and
supplying a second material from the wastewater treatment facility to a cathode compartment, wherein the cathode compartment comprises a cathode, wherein the anode and cathode are in electrical communication.

18. The method of claim 17, wherein the first material is a sludge return, an activated sludge, a filtered activated sludge, or a clarified activated sludge, and wherein the second material is an activated sludge, a filtered activated sludge, a clarified activated sludge, or a disinfecting mixture.

19. The method of claim 17, further comprising retrieving a purified water product from the anode compartment, the cathode compartment, or both.

20. The method of claim 17, wherein the anode compartment and cathode compartment are treatment stages in a wastewater treatment facility, and wherein the anode compartment and cathode compartment are separated by an ion permeable membrane.
